(19) United States
(12) Patent Application Publication
(10) Pub. No.: US 2007/0172015 A1
(43) Pub. Date: Jul. 26, 2007

(54) Nuclear fusion containment complex and systems network for the thermal durational enhancement of contained heat processes

(76) Inventor: Edward Cady Gordon II, Sebring, FL (US)

Correspondence Address: TROJAN LAW OFFICES, 9250 WILSHIRE BLVD, SUITE 325, BEVERLY HILLS, CA, 90212, US

(21) Appl. No.: 11/329,675

(22) Filed: Jan. 10, 2006

(51) Int. Cl. H05H 1/22

(52) U.S. Cl. 376/100

(57) ABSTRACT

A systems network for harnessing nuclear fusion power and, more particularly, a complex for containment of a nuclear fusion detonation reaction, in which the nuclear detonation reaction is used to heat water for application in a steam turbine system that is used to drive a generator. The systems network include a feedwater plant, a steam turbine system, an oxygen producing plant, and a thermal recovery plant, connected to a containment complex having a hydrogen detonation chamber encased in a series of thermal containment chambers having electromagnetically charged walls and an outer structure.

### BACKGROUND OF THE INVENTION

1. Field of the Invention

This invention relates generally to a system for harnessing nuclear fusion detonation power and, more particularly, to a containment complex for a nuclear fusion reaction, and method for containment and recovery of thermal energy to process steam production for electrical power generation.

2. Description of the Prior Art

Nuclear power, the use of sustained nuclear reactions to do useful work, has long been recognized as a potentially limitless sustainable energy source. It is believed by some that nuclear power is an answer to the problems of dwindling oil reserves and the detrimental environmental effects of fossil fuel, such as Greenhouse gas emission that leads to global warming. Furthermore, the raw materials of industry, in the form of mineral concentrations accumulated through exceedingly slow geologic processes occurring over millions of years, are being depleted at an alarming rate. For instance, it takes approximately 200,000 years to make a drop of oil. Consequently, there is a need to develop alternative energy sources, including nuclear power.

Current development of nuclear power is based on fission, the process in which the nucleus of an atom splits into two or more smaller nuclei. In a nuclear fission reactor—a reactor being a device in which nuclear chain reactions are initiated, controlled, and sustained at a steady rate—heat is produced through a controlled nuclear chain reaction in a critical mass of fissile material. All current nuclear power plants are critical fission reactors. However, such reactors are considered controversial for their safety and health risks. Specifically, the production of radioactive waste has proven to be a highly controversial issue in the debate on nuclear energy, resulting in the fact that no new fission reactors have been built in the United States in the last several decades.

As a result of the difficulties and controversies involving fission reactors, there is a desire to develop power systems based on nuclear fusion. It is believed that nuclear fusion offers tremendous possibility for the release of very large amounts of energy with minimal production of radioactive waste and improved safety, making nuclear fusion a power source of great promise. Hence, it is also believed that the harnessing of nuclear fusion power may be the key to eventually solving the current problem of energy supply.

Nuclear fusion is the process by which two nuclei join together to form a heavier nucleus. In order for two nuclei to fuse, they must collide with enough energy to overcome the repulsive electrostatic force between them. When two light nuclei come close enough to each other, they may fuse to form a single nucleus with a slightly smaller mass than the sum of their original masses. This is accompanied by a tremendous release of energy in accordance with the difference in mass.

Generally, most fusion reactions combine isotopes of hydrogen (protium, deuterium or tritium) to form isotopes of helium (3He or 4He). This is because hydrogen, which is the most abundant element in the universe, has the smallest nuclear charge and therefore reacts at the lowest temperature. Helium has an extremely low mass per nucleon and therefore is energetically favored as a fusion product. To cause fusion, the atoms to be fused must be in the form of plasma. Plasma is a high-energy state of matter in which all the electrons are stripped from atoms and move about freely. To achieve plasma, a gas is heated, causing the atoms to move very rapidly, and at high enough temperature, the electrons become separated from the nuclei, thus creating a cloud or blanket of ions—i.e. the plasma.

To produce self-sustaining fusion, the energy released by the reaction (or at least a fraction of it) must be used to heat new reactant nuclei and keep them hot long enough (or thermally insulated against heat loss in a more enhanced way to restrict heat loss) that they also undergo fusion reactions. Retaining the heat is called energy confinement, which refers to all the conditions necessary to keep a plasma dense and hot long enough to undergo fusion. Confinement may be accomplished in a number of ways.

Magnetic confinement is one current method being researched for containment of plasma, in which magnetic fields are used to contain the charged particles that compose the hot plasma and keep it away from the chamber walls (or keep it a distance away from the reaction in which case the heat would be given up). An example of a magnetic confinement device is the Tokamak, a toroidal (i.e. donut-shaped) chamber generating magnetic lines that spiral around the torus for trapping the plasma. However, the use of magnetic confinement has proven to be difficult because the plasma generally exhibits some form of instability that prevents the magnetic field from being able to contain the heated, ionized gas for sufficient time to reach the breakeven point in energy production.

Another method for containment of plasma is inertial confinement, which involves imploding a small fuel pellet. The inertia of the imploding pellet keeps it confined momentarily. Neither of these methods has proven to be a viable method for harnessing fusion power. A simpler and more promising method was proposed in the mid-1970s by the Los Alamos National Laboratory in a project called PACER.

PACER explored the possibility of fusion power system that would involve exploding small nuclear bombs inside an underground cavity. It was proposed that the system would absorb the energy of the explosion in a molten salt, which would then be used in a heat exchanger to heat water for use in a steam turbine. However, such a system would require a massive supply of bombs (because of heat loss due to the heat permeating into the earth surface), making the feasibility of such a system doubtful. The requirement of a massive number of nuclear bombs would also present a very serious security concern.

For the foregoing reasons, there is a need for a system to harness nuclear fusion power and, more particularly, to a containment complex for a nuclear fusion reaction.

### SUMMARY OF THE INVENTION

The present invention provides a containment complex for a nuclear fusion detonation reaction and a system for harnessing the power therefrom. It is the purpose of this invention to trap the heat recovered from a nuclear detonation and not attempt to contain a continuous nuclear reaction as in a formal reactor.

A containment complex having the features of the present invention comprises a hydrogen detonation chamber (or potable reactor) for initiating the nuclear reaction, which is located at center of the containment complex. Surrounding the hydrogen detonation chamber is a series of thermal containment chambers.

In a preferred embodiment of the invention, the containment complex has at least three thermal containment chambers. A first thermal containment chamber, having a bracketed configuration composed of two bracket vessel chambers, encases the hydrogen detonation chamber such that the two bracket vessel chambers open away from the hydrogen detonation chamber in a reverse bracketed configuration. In turn, a second thermal containment chamber, also having a bracketed configuration, encases the first thermal containment chamber, but such that the two bracket vessel chambers opens toward and brackets the first thermal containment chamber. Similarly, a third thermal containment chamber brackets the second containment chamber. The hydrogen detonation chamber and the thermal containment chambers are enclosed in an outer containment structure.

As all fusion (and fission) nuclear facilities and reactor systems generate radioactive waste (having life spans of between 5,000 to 100,000 years), the containment complex is to be insulated against premature contamination as well as heat loss. Therefore, it is contemplated that the thermal containment chambers of the containment complex have surfaces made of reinforced concrete plated on the exterior with plate steel that can be negatively or positively charged to restrict radioactive (positive or negative) charged particles from adhering to the wall, ceiling and floor surfaces of the containment complex. When a positively charged particle attempts to contact a (magnetically) positive charged surface, the positively charged surface restricts such contact. Furthermore, the plated walls may utilize variable conductive properties or materials related to conduct a suitable quantity of electrical charged energy at the wall surfaces so as to repel the positively or negatively charged particles. This would retard the tendency of the radioactive particles to adhere to the vessel walls, floor and ceiling. As a result, the suppression of radioactive contamination enhances the life of the complex.

Further, the steel plated walls of the thermal containment chambers would be electromagnetically charged to generate electrostatic forces for confinement of the plasma ions. It would be recognized by one of ordinary skill in the art that a wall composed of any suitable metallic material can be charged to produce an electromagnetic field. Because at the high temperatures required for fusion, the plasma has high electrical conductivity, it has been recognized that the plasma can be confine by generating an electromagnetic field.

In addition, the interior walls of the containment complex are constructed of reinforced, welded steel frame mounted on inverted steel pedestal shaft columns, to be lowered and raised depending on the internal temperature of the combust plasma in containment complex.

In addition, the thermal containment chambers are fitted with retractable blast doors, which function to control the plasma dispersion. The controlled dispersion of plasma is necessary to regulate the thermal equilibrium of the system. The thermal equilibrium of the system is further regulated by the release of heat via a media containment housing connected to the outer containment structure. The outer containment structure also includes thermal vent ports for controlled thermal ventilation (and may include water conduit piping mounted therein for steam conversion).

In an embodiment of the invention, the walls also contain internal piping to circulate water at the outer wall surface to heat water for steam production, much like a standard coal fire combustion furnace that operates to heat water for steam production. As in a coal fire combustion furnace, steel tubes (or pipes) are mounted on interior side walls for circulation of water, which is then heated and processed as superheated gas at the top of the furnace structure, which conducts heat through the pipe surface to heat water for conversion into steam to be put to use at a steam turbine. The temperature ranges from hundreds of degrees to a few thousand degrees during this process. Generally, these furnaces vary in size; however, large electrical generating plants utilize furnaces that are 13 to 18 stories high. Super heated gas is contained at the top (in the fifth or sixth story). Generally each story contains an increase of heat circulated to exchange.

The containment complex is at the center of a systems network for harnessing nuclear fusion power generated from a detonation device in the containment complex. The systems network is comprised of a feedwater plant that is connected to the containment complex. The feed water plant supplies water for circulation in the containment complex. The circulated water is heated by the detonation reaction under confinement in the containment complex, converting it to steam for application in a steam turbine system, which is connected to the containment complex. In turn, the steam is put to work to drive the turbine system that drives a generator to generate electric energy and power output.

The systems network can also include an oxygen producing plant to enrich oxygen supply for the detonation of the reaction and, conversely, to deplete oxygen supply in the containment complex to create a near vacuum condition for controlling combustion. A thermal combustion recovery power plant connected to the containment complex serves to convert thermal energy for use in the steam turbine system consistent with known electric power generating systems.

The systems network can further include a wastewater treatment plant for processing of wastewater from the containment complex. It is to be noted that Granular Activated Carbon (GAC) can absorb radioisotopes with up to twenty-four minutes of contact time (i.e. time during which GAC is in contact with radioactive isotopes). Whereas the vessel's containment walls are electromagnetically charged to either positive or negative energy equivalents to repel charged radioactive particles, this would further offer a means by which direct restriction related to the contact of radioactive waste particles would be suspended in the air or in the vacuum space rather than adhere to the vessel walls. This would provide a means to restrict such direct radioactive contact directly with the vessel walls, thus retarding the tendency of the radioactive waste particles to adhere or impregnate the vessel walls. In an enhanced wall surface protected with plating, the advantages would be recognized by one of skill in the art. If waste particles cannot adhere to the vessel walls or other internal surfaces of the containment complex, the waste particles are restricted to the air or in the oxygen-depleted space internally held within the complex vessels' chambers. At maintenance intervals waste removal would employ flooding the containment complex with water, which would contain the radioactive waste by volume in terms of admixture, or as waste held in a solution by volume. The waste admixture would suspend and hold the radioactive waste particles in the water to be drained off as a waste discharge to be pumped to a wastewater treatment facility that utilizes GAC to adsorb the radioactive waste particles. In utilizing a wash cycle process to redirect radioactive waste particles from the containment complex to a GAC adsorption media, the waste deposit of the containment complex would be reduced. This would prolong the service life the containment complex. This would also offer a method of reclaiming the radioactive waste particles to be taken-up onto the GAC surfaces for collection adsorption, storage and waste remediation and containment. Further, it would provide as well a safe means of removal from the containment complex of the radioactive waste particles to be back-washed and held onto the GAC and removed safely from the facility, and or, be held as waste and for future fuel-feed-stock if desired. It is to be noted that temperature of GAC needs to remain below 110° so desorption will not occur.

Further, it is to be noted that regarding water treatment, most all power generation plant (steam operated) have their own water treatment plants to make the water suitable for facility use specifically. The caustic property of water is of concern as it relates to the effects on mechanical equipment and machinery. All precautions and preparations in the avoidance of utilizing water in direct contact with internal complex surfaces is highly preferred to avoid structure damages on many levels. Maintenance pre-cooling waste abatement procedures and the necessary water requirements should be taken into account externally of this containment complex and water is not to be operated internally of the complex other than to wash suspended contamination out of the complex. It would be recognized by one of skill in the art that direct contact of water inside the containment complex other than for wash cycling is not recommended. Circulating water through a series of pipe network is sufficient to obtain heated water for steam conversion without the water being in direct contact with the internal vessel's inner surface area.

Lastly, the preferred extraction of radioactive isotopes as fissioned from sea-water, as an example, would be primarily prepared utilizing most likely a desalination process to first render the sea water suitable for fissionable extraction production. Furthermore, by utilizing desalination the cost of the prepared water to be rendered to the fission process are generally recoverable due to the fact that electrical cogeneration may be utilized in the desalination process to sell off the abundant energy in terms of power sales agreement to recover the cost of prepping the water supply. Related to the complex at this time, the demonstrated containment complex does not incorporate a desalination and water treatment plant. Although this type of prepatory water and extraction media would be preferred as a more cost effective manner in which to provide those suitable materials to more efficiently operate the entire power island complex. In fact, it is contemplated that sales of both water and electricity would more than pay for both the electrical generation equipment and operation, and the costs associated with the processed fissionable prepatory fusion feed stock to be collected as well as fissioned.

### BRIEF DESCRIPTION OF THE DRAWINGS

FIG. 1 is a schematic diagram of an embodiment of the systems network of the invention.

FIG. 2 is a schematic diagram of an embodiment of the containment complex of the invention.

### DETAILED DESCRIPTION

In the following description of the preferred embodiments reference is made to the accompanying drawings, which are shown by way of illustration of specific embodiments in which the invention may be practiced. It is to be understood that other embodiments may be utilized and structural and functional changes may be made without departing from the scope of the present invention.

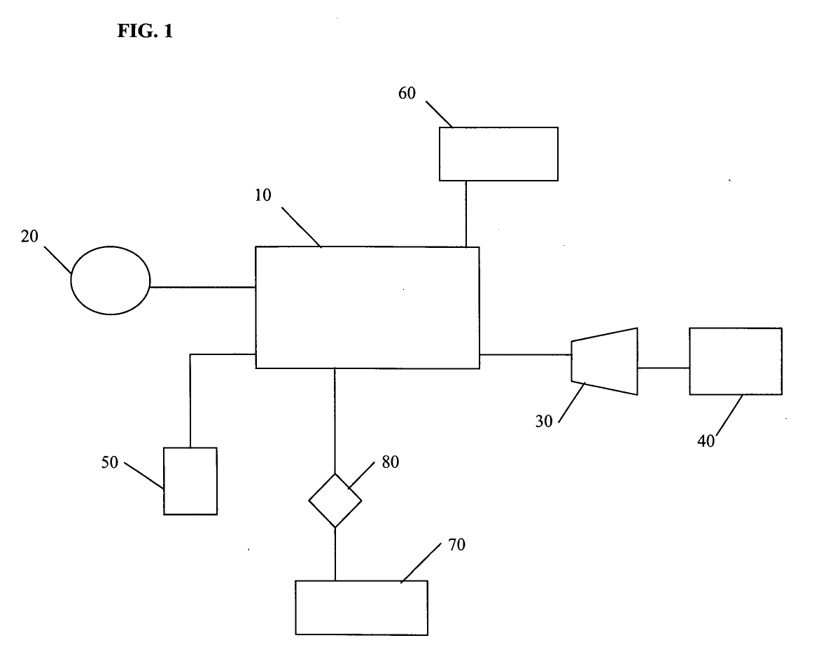

Referring to FIG. 1, at the center of a systems network (1) for harnessing nuclear fusion power is a containment complex (10). A nuclear reaction is generated in hydrogen detonation chamber (12) in containment complex (10). A feedwater plant (20) is connected to the containment complex (10), which supplies water for circulation in the containment complex (10). The circulated water in containment complex (10) is heated by the nuclear reaction in the containment complex (10). The nuclear reaction causes the water to be superheated, thereby converting the circulated water in containment complex (10) to steam. The steam is applied to a steam turbine system (30), which is connected to the containment complex (10) as shown. In turn, the steam turbine system drives a generator (40).

That is, the nuclear reaction acts as an extremely high-energy source of heat. It heats the water and turns it to steam. The steam drives a steam turbine in steam turbine system (30), which spins generator (40) to produce power. In some reactors, the steam from the reactor goes through a secondary, intermediate heat exchanger to convert another loop of water to steam, which drives the turbine. The advantage to this design is that the radioactive water/steam never contacts the turbine. Also, in some reactors, the coolant fluid in contact with the reactor core is gas (carbon dioxide) or liquid metal (sodium, potassium); these types of reactors allow the core to be operated at higher temperatures.

The systems network (1) also includes an oxygen producing plant (50) to enrich oxygen supply for detonation and, conversely, to deplete oxygen supply in the containment complex (10) for controlling combustion. A thermal combustion recovery power plant (60) connected to the containment complex (10) serves to convert thermal energy for use in the steam turbine system (30).

In another embodiment of the invention, the systems network (1) includes a wastewater treatment plant (70) for processing of wastewater from the containment complex (10), and a wastewater pumping station (80) for re-circulation of wastewater.

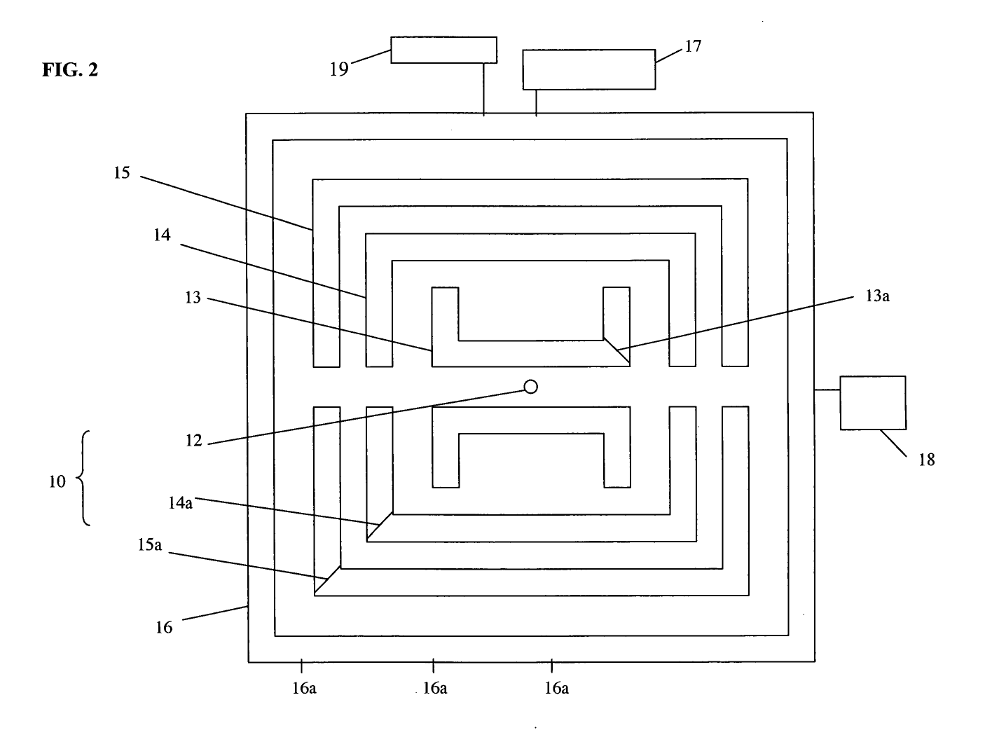

Referring to FIG. 2, the containment complex (10) having the features of the present invention has a hydrogen detonation chamber (12) for initiating the nuclear reaction, located at center of the containment complex (10). The hydrogen detonation chamber (12) is surrounded by a series of thermal containment chambers.

In a preferred embodiment of the invention, the containment complex (10) has at least three containment chambers, each chamber having a bracketed configuration. Specifically, a first thermal containment chamber (13) has a bracketed configuration composed of two vessel chambers in the form of brackets. The first thermal containment chamber (13) encases the hydrogen detonation chamber (12) such that the two bracket vessel chambers open away from the hydrogen detonation chamber in a reverse bracketed configuration. A second thermal containment chamber (14), also having a bracketed configuration, encases the first thermal containment chamber (13). Each of the two bracket vessel chambers of the second thermal containment chamber (14) opens toward and brackets the first thermal containment chamber (13). Similarly, a third thermal containment chamber (15) brackets the second thermal containment chamber (14). The configuration of the thermal containment chambers, and the openings between the chambers and the ceiling of the containment complex (10), are designed to regulate the flow of heat outward towards the circulation system of water supplied by feedwater system (20). The space between the thermal containment chambers (13, 14 and 15) also function as insulators to minimize particle ionization losses. Finally, the hydrogen detonation chamber (12) and the thermal containment chambers (13, 14 and 15) are enclosed in an outer containment structure (16).

The walls of the thermal containment chambers (13, 14 and 15) are made of reinforced concrete with plated plate steel that can be negatively or positively charged to restrict radioactive charged particles from adhering to the wall, ceiling and floor surfaces of the containment complex.

For safety purposes, the outer containment structure (16) is made of concrete of sufficient dimension to withstand catastrophic impact. The concrete outer containment structure (16) acts as a radiation shield, so as to prevent leakage of any radioactive gases or fluids from the containment complex (10). It is contemplated that the outer containment structure (16) has parameters approximating 1000 feet wide and 300 feet (100 m) tall. However, it will be recognized by one skilled in the art that the distance from detonation to the outer containment structure (16) is to be determined by the rating associated with the mega-wattage generated by the reaction.

It is contemplated that the thermal containment chambers of the containment complex would have walls made of approximately 12 foot thick steel alloy. The walls of the thermal containment chambers are to be electromagnetically charged to generate electrostatic forces for confinement of the plasma ions. It would be recognized by one of ordinary skill in the art that a wall composed of any suitable metallic material can be charged to produce an electromagnetic field. An electromagnetic field can effectively confine electrons because at the high temperatures required for fusion, the plasma has high electrical conductivity. The charges at the chamber walls are adjustable independently and charge directly from a facility electric generator, such that the electromagnetic field can be applied to contain the plasma. It would also be recognized by one of ordinary skill in the art that the electromagnetic field further provides a cooling mechanism for electrons, which reduces their radiation loss.

Further, the thermal containment chambers (13, 14 and 15) are fitted with retractable blast doors (13a, 14a and 15a), preferably located at the corners of the bracket vessels of the thermal containment chambers (13, 14 and 15), which function to control heat dispersion. The controlled dispersion of heat is necessary to regulate the thermal equilibrium of the system. The thermal equilibrium of the system is further regulated by the release of heat via a media containment housing (17) connected to the outer containment structure (16). The outer containment structure (16) also includes thermal vent ports (16a) for controlled thermal ventilation.

In another embodiment of the invention, the containment complex (10) includes a remote hydrogen detonation recharge chamber (18) and an external thermal recovery housing (19).

What is claimed is:

1. A containment complex for initiating and containing a nuclear reaction comprising:
a hydrogen detonation chamber for initiating a nuclear reaction;
a first thermal containment chamber having a bracketed configuration in outer relation to said hydrogen detonation chamber;
a second thermal containment chamber having a bracketed configuration in outer relation to said first thermal containment chamber;
a third thermal containment chamber having a bracketed configuration in outer relation to said second containment chamber; and
an outer containment structure in outer relation to said third containment chamber;
a plasma media containment housing for restricting release of superheated plasma generated by said nuclear fusion reaction connected to said outer containment structure;
wherein said hydrogen detonation chamber is located at center of said containment complex, said hydrogen detonation chamber reverse bracketed by said first thermal containment chamber such that said bracket configuration of said first thermal containment chamber opens away from said hydrogen detonation chamber, said second thermal containment chamber encasing said first thermal containment chamber such that said bracket configuration of said second thermal containment chamber opens toward said hydrogen detonation chamber, and said third containment chamber encasing said second thermal containment chamber such that bracket configuration of said third thermal containment chamber opens toward said hydrogen detonation chamber, said third containment chamber enclosed by said outer containment structure.

2. The containment complex as in claim 1 wherein said first, second, and third containment chambers have electromagnetically charged walls for generating electrostatic forces to contain said nuclear reaction.

3. The containment complex as in claim 1 wherein said first, second, and third containment chambers have and retractable blast doors for containing heat and control of air supply dispersion.

4. The containment complex as in claim 1 wherein said outer containment structure includes thermal vent ports for controlled thermal ventilation.

5. The containment complex as in claim 1 further comprising a remote hydrogen detonation recharge chamber.

6. The containment complex as in claim 1 further comprising an external thermal recovery housing.

7. A systems network for harnessing nuclear fusion power comprising:
a feedwater plant;
said feedwater plant connected to a containment complex;
said containment complex connected to a steam turbine system; and
said steam turbine system connected to a generator for power output;
wherein said feedwater plant is capable of supplying water for circulation in said containment complex, said containment complex capable of initiating and containing a nuclear reaction, the nuclear reaction causing the water to be superheated in said containment complex, causing the superheated water to convert to steam for application in said steam turbine system, thereby causing said steam turbine system driving said generator.

8. The systems network as in claim 7 further comprising:
an oxygen producing plant to enrich oxygen supply for detonation and to deplete oxygen supply in said containment complex for combustion.

9. The systems network as in claim 7 further comprising:
a thermal combustion recovery power plant connected to said containment complex for conversion of thermal energy for use in power plant.

10. The systems network as in claim 7 further comprising:
a wastewater treatment plant for processing of wastewater from said containment complex; and
a wastewater pumping station for re-circulation of wastewater.
